(19) United States
(12) Patent Application Publication
(10) Pub. No.: US 2012/0041939 A1
(43) Pub. Date: Feb. 16, 2012

(54) System and Method for Unification of User Identifiers in Web Harvesting

(76) Inventor: Lior Amsterdamski, Petach Tikva (IL)

(21) Appl. No.: 13/187,438

(22) Filed: Jul. 20, 2011

(30) Foreign Application Priority Data
Jul. 21, 2010 (IL) 207123

(51) Int. Cl. G06F 17/30

(52) U.S. Cl. 707/709; 707/E17.108

(57) ABSTRACT

Web Intelligence that automatically associate different user identifiers that belong to the same user. An analytics system may include a Web crawler that crawls Web-sites of interest, e.g., social media Web-sites. The Web crawler retrieves from the Web-sites data items that were posted by users, who identified themselves on the Web-sites using various user identifiers (e.g., usernames or nicknames). The system may further include a correlation processor that automatically correlates user identifiers that appear in the retrieved data items. The correlation processor may identify different user identifiers that are used by the same user on different Web-sites. Once two or more identifiers have been associated with a given user, the network content and network activity of that user can be jointly analyzed and acted upon.

### FIELD OF THE DISCLOSURE

The present disclosure relates generally to data mining, and particularly to methods and systems for associating user identifiers with network users.

### BACKGROUND OF THE DISCLOSURE

Several methods and systems for analyzing information extracted from the Internet are known in the art. Such methods and systems are used by a variety of organizations, such as intelligence, analysis, security, government and law enforcement agencies. For example, Verint® Systems Inc. (Melville, N.Y.) offers several Web Intelligence (WEBINT) solutions that collect, analyze and present Internet content.

### SUMMARY OF THE DISCLOSURE

An embodiment that is described herein provides a method, including:

crawling at least first and second Web-sites, which include data items that were posted on the Web-sites by users, so as to retrieve respective first and second pluralities of the data items;

extracting from the data items in the first plurality first identifiers, which are indicative of the respective users who posted the data items on the first Web-site, and extracting from the data items in the second plurality second identifiers, which are indicative of the respective users who posted the data items on the second Web-site;

identifying a correlation between at least one of the first identifiers and at least one of the second identifiers that is different from the at least one of the first identifiers; and

responsively to the correlation, associating both the at least one of the first identifiers and the at least one of the second identifiers with a given user.

In some embodiments, identifying the correlation includes extracting first metadata from the data items in the first plurality, extracting second metadata from the data items in the second plurality, and finding a similarity between the first and second metadata. In an embodiment, the first and second metadata include first and second personal information, which were provided upon registration with the first and second Web-sites, respectively, and finding the similarity includes detecting the similarity between the first and second personal information. In a disclosed embodiment, the first and second metadata include first and second links to first and second personal pages, respectively, and finding the similarity includes detecting the similarity between the first and second personal pages.

In some embodiments, identifying the correlation includes finding a grammatical similarity between the at least one of the first identifiers and the at least one of the second identifiers. In an embodiment, identifying the correlation includes determining a first set of social contacts of the at least one of the first identifiers and a second set of the social contacts of the at least one of the second identifiers, and identifying a commonality between the first and second sets. In another embodiment, identifying the correlation includes identifying two or more different correlation types between the at least one of the first identifiers and the at least one of the second identifiers, assigning respective scores to the different correlation types, and combining the scores so as to produce the correlation.

In yet another embodiment, associating the identifiers with the given user includes producing for the given user a unified identity, which includes the at least one of the first identifiers, the at least one of the second identifiers, and additional personal information of the given user that is extracted from the data items. In an embodiment, the unified identity is produced at a first time, and the method includes updating the unified identity, at a second time later than the first time, with at least one additional identifier that is associated with the given user.

In another embodiment, crawling the first and second Web-sites includes retrieving the first and second pluralities of the data items based on respective first and second predefined crawling templates. In a disclosed embodiment, the method includes tracking network activity of the given user using the associated at least one of the first identifiers and at least one of the second identifiers.

There is additionally provided, in accordance with an embodiment that is described herein, apparatus, including:

a network interface for connecting to a communication network that includes at least first and second Web-sites, which include data items that were posted on the Web-sites by users; and

a processor, which is configured to crawl the first and second Web-sites so as to retrieve respective first and second pluralities of the data items, to extract from the data items in the first plurality first identifiers, which are indicative of the respective users who posted the data items on the first Web-site, to extract from the data items in the second plurality second identifiers, which are indicative of the respective users who posted the data items on the second Web-site, to identify a correlation between at least one of the first identifiers and at least one of the second identifiers that is different from the at least one of the first identifiers, and, to associate both the at least one of the first identifiers and the at least one of the second identifiers with a given user responsively to the correlation.

There is also provided, in accordance with an embodiment that is described herein, a computer software product, including a non-transitory tangible computer-readable medium, in which program instructions are stored, which instructions, when read by a computer, cause the computer to crawl at least first and second Web-sites, which include data items that were posted on the Web-sites by users, so as to retrieve respective first and second pluralities of the data items, to extract from the data items in the first plurality first identifiers, which are indicative of the respective users who posted the data items on the first Web-site, to extract from the data items in the second plurality second identifiers, which are indicative of the respective users who posted the data items on the second Web-site, to identify a correlation between at least one of the first identifiers and at least one of the second identifiers that is different from the at least one of the first identifiers, and to associate both the at least one of the first identifiers and the at least one of the second identifiers with a given user responsively to the correlation.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an analytics system, in accordance with an embodiment of the present disclosure;

FIG. 2 is a diagram that schematically illustrates unification of user identifiers, in accordance with an embodiment of the present disclosure; and

FIG. 3 is a flow chart that schematically illustrates a method for unification of user identifiers, in accordance with an embodiment of the present disclosure.

### DETAILED DESCRIPTION OF EMBODIMENTS

### Overview

Users of social networks, forums, blogs and other social media Web-sites typically identify themselves using user identifiers such as usernames and nicknames (“nicks”). It is common for a given user to use different identifiers on different Web-sites. For example, a user called David Moon may use the username “davidmoon” in his personal blog and the nick “dmoon1” in a certain Web forum. As another example, a user may own several e-mail accounts and use them to register with different social media Web-sites. The use of multiple identifiers makes it difficult for Web Intelligence (WEBINT) systems to associate Internet content with users.

Embodiments that are described hereinbelow provide improved WEBINT techniques, which automatically associate different user identifiers that belong to the same user. In some embodiments, an analytics system comprises a Web crawler that crawls Web-sites of interest, e.g., social media Web-sites. The Web crawler retrieves from the Web-sites data items that were posted by users, who identified themselves on the Web-sites using various user identifiers (e.g., usernames or nicknames).

The system further comprises a correlation processor, which automatically correlates user identifiers that appear in the retrieved data items. In particular, the correlation processor identifies different user identifiers that are used by the same user on different Web-sites. Once two or more identifiers have been associated with a given user, the network content and network activity of that user can be jointly analyzed and acted upon. Several example techniques for detecting different identifiers that belong to the same user are described herein.

The methods and systems described herein enhance the information available to WEBINT analysts, and enable them to track the network activity of Internet users in spite of the multiple different identifiers that may be used by the users.

### System Description

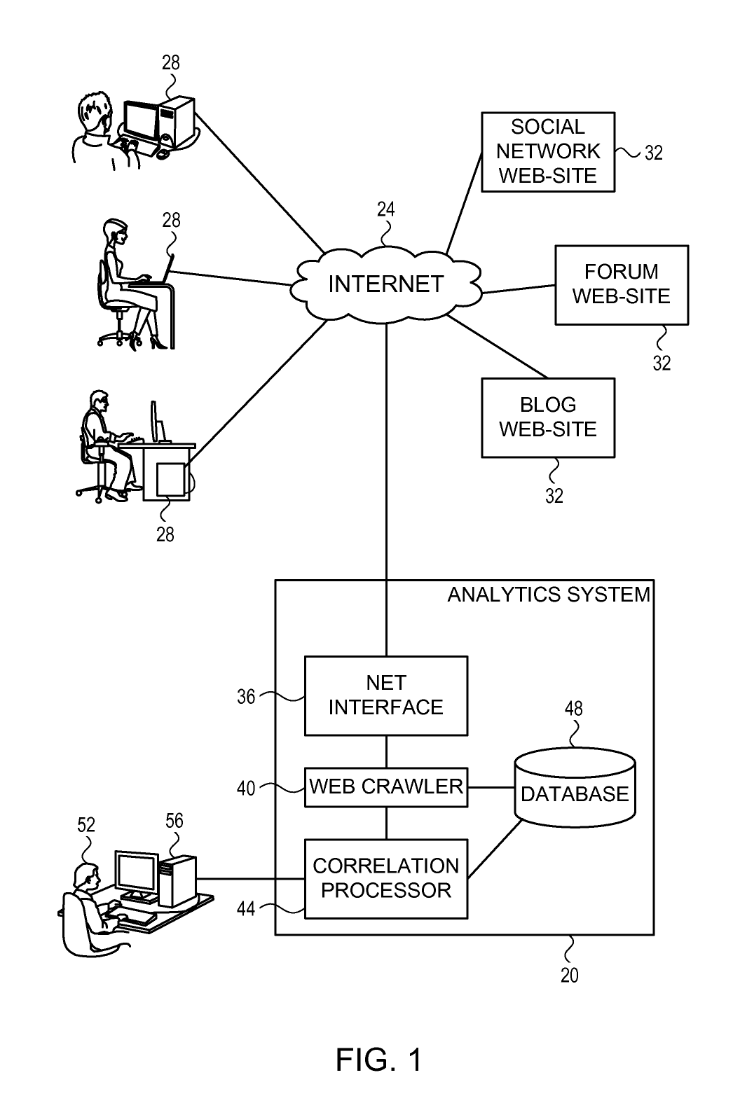

FIG. 1 is a block diagram that schematically illustrates an analytics system 20, in accordance with an embodiment of the present disclosure. System 20 is connected to a Wide-Area Network (WAN) 24, typically the Internet, in order to carry out Web Intelligence (WEBINT) and other analytics functions. System 20 can be used, for example, by various intelligence, analysis, security, government and law enforcement organizations.

In network 24, users 28 post content on various Web-sites 32. For example, users may post Web pages on blogs and social network sites, interact with one another using Instant Messaging (IM) sites, post threads on Web forums, respond to news articles using talkback messages, or post various other kinds of data items.

The embodiments described herein are mainly concerned with social media such as social networks, forums, blogs, Instant Messaging (IM) and on-line comments to newspaper articles, but the disclosed techniques can also be used in any other suitable type of Web-site. Generally, the methods and systems described herein can be used with any Web-site that allows users to annotate the Web-site content (e.g., comment or rate content) and/or to interact with one another in relation to the Web-site content. Web-sites may implement these features using various tools, such as “Google Friend Connect” or “Facebook Connect.” As another example, Web-based e-mail sites often support social network capabilities, such as “Yahoo! Updates” or “Google Buzz.” As yet another example, on-line storage services such as “Windows Live Skydrive” allow users to upload, annotate and share files. Web-sites such as Picassa and Flickr allow users to upload, annotate and share image albums.

Other Web-sites offer niche social networks, such as “last.fm” or “imeem” for music, or “flixter” for movie reviews and rating. On-line billboards and e-commerce Web-sites such as eBay, Amazon or craigslist allow users to upload content and personal profiles, annotate uploaded content, and provide ratings and comments. Web-based e-mail sites allow users to upload contact lists and details. Other example types of Web-sites are on-line dating services, payment authentication services such as PayPal. Further alternatively, the disclosed techniques can be used with any Web-site that allows users to sign-in and upload data items. Some Web-sites, e.g., the Internet Movie Databases (IMDb) implement social network capabilities using proprietary technology. Other Web-sites use third-party tools such as Loopt.

Typically, a given user identifies on a given Web-site using a certain identifier. An identifier may comprise, for example, a username or a nickname (“nick”).

In some Web-sites, users sign-in using their e-mail addresses in combination with a site-specific password, in which case the e-mail address serves as an identifier. In some cases, e.g., in some location-based services, users identify on a Web-site using their telephone numbers, and the telephone numbers can therefore be used as identifiers. As another example, some Web-sites use a third-party application (e.g., Facebook) in order to identify users and allow access to personal information such as friend lists and profile images.

As yet another example, some Web-sites allow users to claim vanity Uniform Resource Locators (URLs). A vanity URL in combination with a username or e-mail address is sometimes used for authentication. With Web-sites of this sort, a vanity URL can be regarded as an identifier. Some Web-sites, e.g., OpenID, users may validate themselves through a third-party URL, and this URL can be used as an identifier. In most Web-sites, the user selects the user identifier when he or she registers with the Web-site in question, and this identifier appears in the data items posted by the user on that site.

It is very common for a given user to use different user identifiers on different Web-sites. The use of multiple identifiers may be innocent or hostile. Innocent users may use different identifiers for privacy, for style or for any other reason. Hostile users, such as criminals or terrorists, may use different identifiers in order to evade surveillance. System 20 applies various criteria for detecting and associating different identifiers that are used by the same user on different Web-sites.

System 20 comprises a network interface 36 for communicating with network 24. A Web crawler 40 crawls Web-sites 32 and retrieves data items that were posted on the Web-sites by users 28. Data items may comprise, for example, social network or blog posts, forum or IM messages, talkback responses and/or any other suitable type of data items. Each retrieved data item was posted on a certain Web-site 32 by a certain user 28, and comprises a certain identifier that is associated with that user. Data items that were posted by the same user on different Web-sites 32, however, may comprise different user identifiers.

A correlation processor 44 extracts the user identifiers from the retrieved data items, and correlates different identifiers from different Web-sites using methods that are described further below. Typically, processor 44 identifies two or more user identifiers that belong to a given user and creates a unified identity, which comprises the user identifiers and may comprise other information pertaining to the user.

Web-crawler 40 and correlation processor 44 store retrieved data items, extracted identifiers, unified identities and/or any other relevant information in a database 48. Database 48 may comprise any suitable storage device, such as one or more magnetic disks or solid-state memory devices, and may hold the information in any suitable data structure. In some embodiments, processor 44 extracts from the retrieved data items personal information regarding users 28, and stores the personal information in database 48 as part of the users' unified identities. Personal information may comprise, for example, e-mail addresses, physical addresses, telephone numbers, dates of birth, photographs and/or any other suitable information.

Information extracted from the retrieved data items can be stored in database 48 using various types of data structures. In an embodiment, the data is stored in a hierarchical data structure, which enables straightforward access and analysis of the information. For example, when extracting information from a forum discussion, the data structure may comprise a table listing the threads appearing in the forum. A related table may list the content and responses of users in each thread. In an embodiment, the data structure enables uniform storage of information that was gathered from multiple different types of Web-sites, e.g., forums and social networks. The data structure may comprise a centralized table of users, which holds user information such as e-mail addresses, user identifiers and photographs, gathered from multiple Web-sites. In an embodiment, the database enables storage and retrieval of textual information as well as binary information (e.g., images and attached documents). In an embodiment, the data structure is implemented using Structured Query Language (SQL).

System 20 presents the unified identities and any other relevant information to an operator 52 (typically an analyst) using an operator terminal 56. Operator terminal 56 comprises suitable input and output devices for presenting information to operator 52 and for allowing the operator to manipulate the information and otherwise control system 20. For example, the operator may access the entire body of data items posted by a given user, including data items that were retrieved from multiple Web-sites and have multiple user identifiers. By jointly accessing all the content associated with a given user, gathered from multiple social media Web-sites, the analyst is able to track the network activity of the user in question.

In some embodiments, Web crawler 40 crawls a predefined list of social media Web-sites that are of interest. In an example embodiment, the Web crawler is provided with a crawling template, or data mining template, for each Web-site or for each type of web-site. The template defines the logic and criteria for retrieving data items, for extracting user identifiers from data items, and for identifying additional information in the data items that assists in identifier correlation.

Typically, system 20 retrieves data items, extracts and correlates user identifiers in a data-centric manner, i.e., without focusing a-priori on any specific target users. The output of such a process is a database of unified identities, each comprising a set of user identifiers and other information related to a respective user. The analyst may query this database when the need arises. For example, when one identifier of a certain target user is known, the database can be queried in order to find other identifiers that are used by the target user, and thus access additional Web content posted by this user on other Web-sites. In alternative embodiments, however, system 20 may operate in a target-centric manner, i.e., focus on data items and identifiers belonging to specific target users.

In some embodiments, crawler 40 crawls data items that are not normally accessible to search engines, such as data items that normally require human data entry for access (e.g., entry of user credentials, checking of a check box, selection from a list, or entry of a query that causes generation of the data item on-demand).

The system configuration shown in FIG. 1 is an example configuration, which is chosen purely for the sake of conceptual clarity. In alternative embodiments, any other suitable system configuration can also be used. For example, the system may comprise two or more Web crawlers instead of one. Web crawler 40 and correlation processor 44 may be implemented on a single computing platform. In some embodiments, system 20 may carry out additional WEBINT and/or analytics functions. Typically, Web crawler 40 and/or correlation processor 44 comprise general-purpose computers, which are programmed in software to carry out the functions described herein. The software may be downloaded to the computers in electronic form, over a network, for example, or it may, alternatively or additionally, be provided and/or stored on non-transitory tangible media, such as magnetic, optical, or electronic memory.

### Unification of User Identifiers

Correlation processor 44 may apply various techniques for correlating different user identifiers that were obtained from different Web-sites. In some embodiments, the data items comprise metadata that is indicative of the user. Processor 44 may use this metadata in order to assess whether different identifiers belong to the same user.

For example, when a user registers with a Web-site and selects a user identifier, the user is typically requested to enter personal information such as country or residence, e-mail address and date of birth. In some embodiments, processor 44 identifies similarities between the personal information on different Web-sites, and uses these similarities as an indication that the respective user identifiers may belong to the same user. For example, two user identifiers (in two different Web-sites) that were registered using the same e-mail address are highly likely to belong to the same user. As another example, two user identifiers that were registered using the same country of residence and date of birth have only medium likelihood of belonging to the same user. In the latter example, processor 44 will typically regard the two user identifiers as representing the same user only if this decision is supported by additional indication that increase its likelihood.

Another type of metadata that can be used for correlating identifiers is links to Web pages that appear in the data items. In some cases, a user may insert a link that points to his personal profile page on a certain Web-site. If two data items, which were retrieved from different Web-sites and have different user identifiers, contain links to the same personal profile page, processor 44 may conclude that the two user identifiers are likely to belong to the same user. Note that this technique applies to certain types of links (e.g., links to personal profile pages) and not to links in general. For example, two data items containing links to a company homepage were not necessarily posted by the same user. Thus, processor 44 may analyze the links found in the data items in order to identify links that are indicative of correlation.

In some embodiments, processor 44 finds grammatical similarities between the user identifiers, and uses these similarities as an indication of correlation between them. For example, the usernames “dmoon” and “davidmoon” have some likelihood of belonging to the same user, whereas the usernames “dmoon” and “jsmith” are likely to belong to different users. For this purpose, processor 44 may use predefined criteria or heuristics. For example, users often select identifiers that consist of their first initial followed by their last name, identifiers that consist of their first name followed by the first letter of their last name, or identifiers consisting of their first name followed by their last name. Processor 44 may use these grammatical conventions in order to find similarities between identifiers and associate them with a single user.

As another example, processor 44 considers multiple spelling options of a given name. Processor 44 may regard two identifiers that correspond to the same but spelled differently as potentially correlated. For example, “kim” and “Kimberley” typically correspond to the same name, as do “yaser” and “Yasser.” As yet another example, some users include an indication of their birth date as part of their usernames. Processor 44 may identify these indications and use them as means for correlation between identifiers. For example, the identifiers “Sputnik” and “sputnik78” may be assigned a high degree of correlation if “Sputnik” is known to have a birth date in 1978.

In some embodiments, processor 44 can deduce that different user identifiers belong to the same user by examining the social interactions, or social relationships, of these identifiers. Typically, two user identifiers that have a large number of common social connections (i.e., a large number of identifiers or users with which they both interact) have a high likelihood of belonging to the same user.

Processor 44 may detect a social relationship between users in various ways, e.g., by detecting users who are defined as related (e.g., “contacts,” “friends” or “followers”) in a social network Web-site, by identifying users who together tag images in social networks or image or album Web-sites, by identifying a user who responds to content posted by another user, by detecting a user who participates in the same forum thread as another user, by detecting users who communicate with one another using IM, or using any other suitable technique.

In some embodiments, processor 44 uses a combination of techniques (a combination of different correlation types) for assessing whether certain user identifiers belong to the same user. Different criteria or techniques may have different confidence levels in indicating such a correlation. In some embodiments, processor 44 assigns each criterion (correlation type) a certain score, and combines the scores in order to determine a total score for the correlation between the identifiers. Thus, a number of relatively weak indications for a pair of identifiers may accumulate and nevertheless indicate a high likelihood of belonging to the same user. For example, two identifiers that were registered using the same country of residence and date of birth will typically receive a low score when considered by themselves. If, however, the two identifiers are also characterized by a large group of common social connections, their total score is typically high, and they can be regarded as belonging to the same user.

Additionally or alternatively, processor 44 may find correlations between user identifiers using any other suitable criterion or technique. For example, processor 44 may further increase the confidence of correlation by detecting additional characteristics of the data items. In an example embodiment, processor 44 may regard data items that use specific slang, or data items that are written entirely in capital red letters, as potentially belonging to the same user.

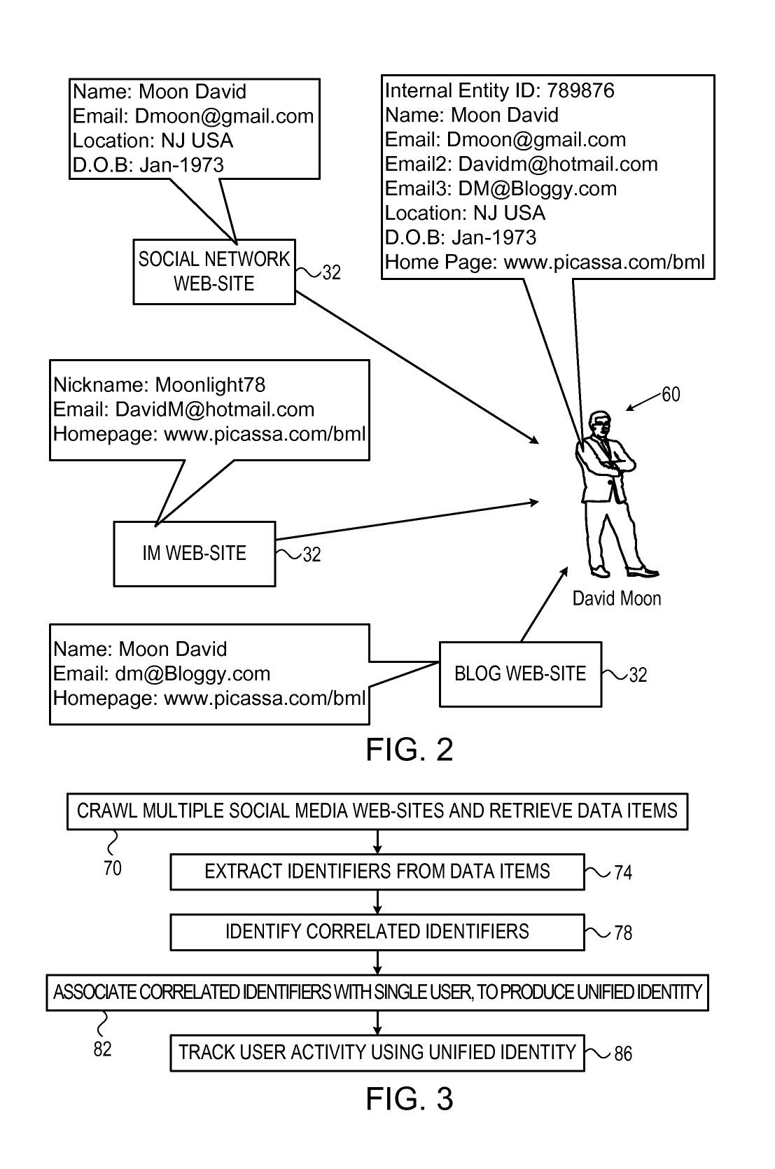

FIG. 2 is a diagram that schematically illustrates unification of user identifiers, in accordance with an embodiment of the present disclosure. In the present example, system 20 retrieves data items from three Web-sites 32, namely a social network site, an IM site and a blog site. When examining the data items, processor 44 detects that a data item retrieved from the IM site and a data item retrieved from the blog site both contain a link to the same personal profile page (www.picassa.com.bm in the present example). Based on this indication, processor 44 concludes that the two identifiers appearing in these two data items (“Moonlight78” and “Moon David”) are likely to belong to the same user. Consequently, processor 44 concludes that this user owns the two e-mail addresses that appear in the two data items (“DavidM@hotmail.com” and “dm@Bloggy.com”).

Based on this information, processor 44 generates a unified identity 60, which represent the user in question. The unified identity initially comprises the two user identifiers (“Moonlight78” and “Moon David”), the two e-mail addresses (“DavidM@hotmail.com” and “dm@Bloggy.com”), and the network address of the user's profile page (www.picassa.com.bm). Processor 44 stores the unified identity in database 48.

At a later point in time, processor 44 finds a data item that was retrieved from the social network site, and which contains a similar user identifier (“Moon David”). The correlation between this identifier and the identifiers that are already part of the unified identity may be further strengthened by other factors, such as social connections. Processor 44 thus decides to add the new identifier to the unified identity. At this stage, unified identity 60 comprises three e-mail addresses (“DavidM@hotmail.com”, “dm@Bloggy.com” and “Dmoon@gmail.com”), the network address of the user's profile page, as well as the address and date of birth of the user, which were obtained from the data item in the social network site. As explained above, operator 52 of system 20 can access the entire body of data items that were posted by this user by using the unified identity. The example also demonstrates that unified identities can be modified over time, as additional data items (or updated versions of existing data items) are crawled and retrieved.

FIG. 3 is a flow chart that schematically illustrates a method for unification of user identifiers, in accordance with an embodiment of the present disclosure. The method begins with Web crawler 40 crawling multiple social media Web-sites, at a crawling step 70. The Web crawler retrieves data items from the crawled Web-sites, and stores the retrieved data items in database 48. Correlation processor 44 extracts user identifiers from the retrieved data items, at an identifier retrieval step 74. Processor 44 finds correlations among user identifiers and identifies a group of two or more identifiers that belong to the same user, at a correlation step 78. Processor 44 may use any of the correlation methods described above, or any other suitable technique.

Processor 44 produces a unified identity of the user in question from the correlated identifiers, at a unified identity generation step 82. The unified identity comprises the different identifiers that were identified as belonging to the user, and additional information related to the user (e.g., personal information and photograph) that was extracted from the data items. System 20 tracks the network activity of the user using the unified identity, at a tracking step 86.

Although the embodiments described herein mainly address individual users, the disclosed techniques can also be used with identifiers that identify other entities, such as groups of users. Although the embodiments described herein mainly address associating user identifiers appearing in Internet content, the principles of the present disclosure can also be used for any other suitable application.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. A method, comprising:
crawling at least first and second Web-sites, which comprise data items that were posted on the Web-sites by users, so as to retrieve respective first and second pluralities of the data items;
extracting from the data items in the first plurality first identifiers, which are indicative of the respective users who posted the data items on the first Web-site, and extracting from the data items in the second plurality second identifiers, which are indicative of the respective users who posted the data items on the second Web-site;
identifying a correlation between at least one of the first identifiers and at least one of the second identifiers that is different from the at least one of the first identifiers; and
responsively to the correlation, associating both the at least one of the first identifiers and the at least one of the second identifiers with a given user.

2. The method according to claim 1, wherein identifying the correlation comprises extracting first metadata from the data items in the first plurality, extracting second metadata from the data items in the second plurality, and finding a similarity between the first and second metadata.

3. The method according to claim 2, wherein the first and second metadata comprise first and second personal information, which were provided upon registration with the first and second Web-sites, respectively, and wherein finding the similarity comprises detecting the similarity between the first and second personal information.

4. The method according to claim 2, wherein the first and second metadata comprise first and second links to first and second personal pages, respectively, and wherein finding the similarity comprises detecting the similarity between the first and second personal pages.

5. The method according to claim 1, wherein identifying the correlation comprises finding a grammatical similarity between the at least one of the first identifiers and the at least one of the second identifiers.

6. The method according to claim 1, wherein identifying the correlation comprises determining a first set of social contacts of the at least one of the first identifiers and a second set of the social contacts of the at least one of the second identifiers, and identifying a commonality between the first and second sets.

7. The method according to claim 1, wherein identifying the correlation comprises identifying two or more different correlation types between the at least one of the first identifiers and the at least one of the second identifiers, assigning respective scores to the different correlation types, and combining the scores so as to produce the correlation.

8. The method according to claim 1, wherein associating the identifiers with the given user comprises producing for the given user a unified identity, which comprises the at least one of the first identifiers, the at least one of the second identifiers, and additional personal information of the given user that is extracted from the data items.

9. The method according to claim 8, wherein the unified identity is produced at a first time, and comprising updating the unified identity, at a second time later than the first time, with at least one additional identifier that is associated with the given user.

10. The method according to claim 1, and comprising tracking network activity of the given user using the associated at least one of the first identifiers and at least one of the second identifiers.

11. Apparatus, comprising:
a network interface for connecting to a communication network that includes at least first and second Web-sites, which comprise data items that were posted on the Web-sites by users; and
a processor, which is configured to crawl the first and second Web-sites so as to retrieve respective first and second pluralities of the data items, to extract from the data items in the first plurality first identifiers, which are indicative of the respective users who posted the data items on the first Web-site, to extract from the data items in the second plurality second identifiers, which are indicative of the respective users who posted the data items on the second Web-site, to identify a correlation between at least one of the first identifiers and at least one of the second identifiers that is different from the at least one of the first identifiers, and, to associate both the at least one of the first identifiers and the at least one of the second identifiers with a given user responsively to the correlation.

12. The apparatus according to claim 11, wherein the processor is configured to identify the correlation by extracting first metadata from the data items in the first plurality, extracting second metadata from the data items in the second plurality, and finding a similarity between the first and second metadata.

13. The apparatus according to claim 12, wherein the first and second metadata comprise first and second personal information, which were provided upon registration with the first and second Web-sites, respectively, and wherein the processor is configured to identify the correlation by finding the similarity between the first and second personal information.

14. The apparatus according to claim 12, wherein the first and second metadata comprise first and second links to first and second personal pages, respectively, and wherein the processor is configured to identify the correlation by finding the similarity between the first and second personal pages.

15. The apparatus according to claim 11, wherein the processor is configured to identify the correlation by finding a grammatical similarity between the at least one of the first identifiers and the at least one of the second identifiers.

16. The apparatus according to claim 11, wherein the processor is configured to determine a first set of social contacts of the at least one of the first identifiers and a second set of the social contacts of the at least one of the second identifiers, and to identify the correlation by identifying a commonality between the first and second sets.

17. The apparatus according to claim 11, wherein the processor is configured to identify two or more different correlation types between the at least one of the first identifiers and the at least one of the second identifiers, to assign respective scores to the different correlation types, and to combine the scores so as to produce the correlation.

18. The apparatus according to claim 11, wherein the processor is configured to produce for the given user a unified identity, which comprises the at least one of the first identifiers, the at least one of the second identifiers, and additional personal information of the given user that is extracted from the data items.

19. The apparatus according to claim 18, wherein the unified identity is produced at a first time, and wherein the processor is configured to update the unified identity at a second time later than the first time with at least one additional identifier that is associated with the given user.

20. A computer software product, comprising a non-transitory tangible computer-readable medium, in which program instructions are stored, which instructions, when read by a computer, cause the computer to crawl at least first and second Web-sites, which comprise data items that were posted on the Web-sites by users, so as to retrieve respective first and second pluralities of the data items, to extract from the data items in the first plurality first identifiers, which are indicative of the respective users who posted the data items on the first Web-site, to extract from the data items in the second plurality second identifiers, which are indicative of the respective users who posted the data items on the second Web-site, to identify a correlation between at least one of the first identifiers and at least one of the second identifiers that is different from the at least one of the first identifiers, and to associate both the at least one of the first identifiers and the at least one of the second identifiers with a given user responsively to the correlation.
